(19) United States
(12) Patent Application Publication
(10) Pub. No.: US 2011/0018802 A1
(43) Pub. Date: Jan. 27, 2011

(54) Remote Control Device and Multimedia System

(76) Inventors: Kuang-Feng Sung, Taichung County (TW); Chun-Ching Huang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/774,704

(22) Filed: May 5, 2010

(30) Foreign Application Priority Data
Jul. 22, 2009 (TW) 098124720

(51) Int. Cl. G06F 3/033

(52) U.S. Cl. 345/158

(57) ABSTRACT

A remote control device for a multimedia device includes a housing, a touch pad placed on a plane of the housing and comprising a dedicated touch area, a signal determination unit placed inside the housing and coupled to the touch pad for generating an indication signal corresponding to an output effect when the dedicated touch area receives a touch signal, and a wireless transmitter placed inside the housing and coupled to the signal determination unit for wirelessly transmitting the indication signal to the multimedia device to control the multimedia device to reach the output effect.

### BACKGROUND OF THE INVENTION

1. Field of the Invention

The present invention relates to a remote control device and multimedia system, and more particularly, to a remote control device and multimedia system capable of enhancing utilization convenience.

2. Description of the Prior Art

With the development of multimedia technology, a variety of multimedia devices have become a part of life in modern society, so that consumer multimedia products, such as television (TV) sets, hi-fi equipments, projectors, digital versatile disc players etc., have been widely used. Facilitating control of various functions, most of the multimedia devices include corresponding remote controllers.

When a user intends to command a multimedia device to perform a function via a corresponding remote controller, the user can press a button corresponding to the function on the remote controller, allowing the remote controller to emit wireless control signals carrying specific information corresponding to the function. After receiving the control signal, the multimedia device interprets the specific information and performs related function accordingly. Such push-button remote controller is commonly applied in the prior art. However, since a font size shown on the remote controller is limited, it is inconvenient, especially for users with poor eyesight, and thus, unsuitable for an aging society. For example, a presbyopic user usually needs to wear a pair of glasses to read positions of the buttons to operate the remote controller, and takes off the pair of glasses to see TV programs, causing inconvenience each time when operating the remote controller.

In addition, each button of the remote controller is usually made of plastic or rubber-based material with carbon powder coated on a surface facing an inner circuit board. By pressing the button, the surface of carbon coat contacts with the circuit board, to generate control signals. This kind of remote controller results in low manufacturing cost, but can lead to poor contact due to dust and overuse. As a result, the remote controller may be unusable due to a few buttons having bad contacting issue.

For this reason, there is a need to improve the conventional remote controller.

### SUMMARY OF THE INVENTION

It is therefore an objective of the present invention to provide a remote control device and multimedia system.

The present invention discloses a remote control device for a multimedia device, which comprises a housing, a touch pad placed on a plane of the housing and comprising a dedicated touch area, a signal determination unit placed inside the housing and coupled to the touch pad for generating an indication signal corresponding to an output effect when the dedicated touch area receiving a touch signal, and a wireless transmitter placed inside the housing and coupled to the signal determination unit for wirelessly transmitting the indication signal to the multimedia device to control the multimedia device to perform the output effect.

The present invention further discloses a multimedia system, which comprises a remote control device and a multimedia device. The remote control device comprises a housing, a touch pad placed on a plane of the housing and comprising a dedicated touch area, a signal determination unit placed inside the housing and coupled to the touch pad for generating an indication signal corresponding to an output effect when the dedicated touch area receiving a touch signal, and a wireless transmitter placed inside the housing and coupled to the signal determination unit for wirelessly transmitting the indication signal to the multimedia device. The multimedia device comprises an operation circuit, a wireless receiver for wirelessly receiving the indication signal, and a control unit coupled to the operation circuit and the wireless receiver for controlling the operation circuit to perform the output effect according to the indication signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a multimedia system according to an embodiment of the present invention.

FIG. 1B is a functional block diagram of the multimedia system shown in FIG. 1A.

FIG. 2 is a schematic diagram of a remote control device of the multimedia system shown in FIG. 1A.

FIGS. 3A, 3B and 3C are schematic diagrams of front view, lateral view and back view of a remote control device used in the multimedia system shown in FIG. 1A.

FIGS. 4A and 4B are schematic diagrams of operations when the remote control device shown in FIG. 2 used in the multimedia system shown in FIG. 1A.

### DETAILED DESCRIPTION

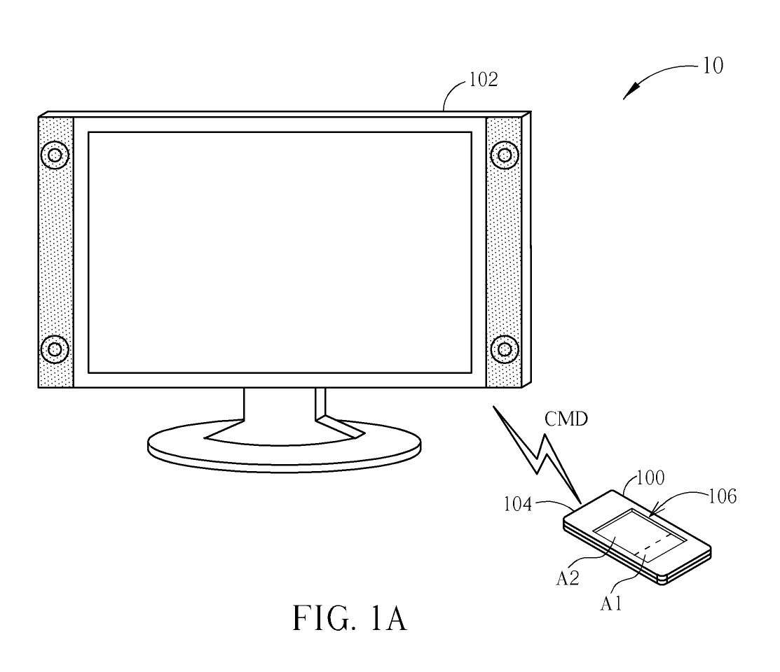

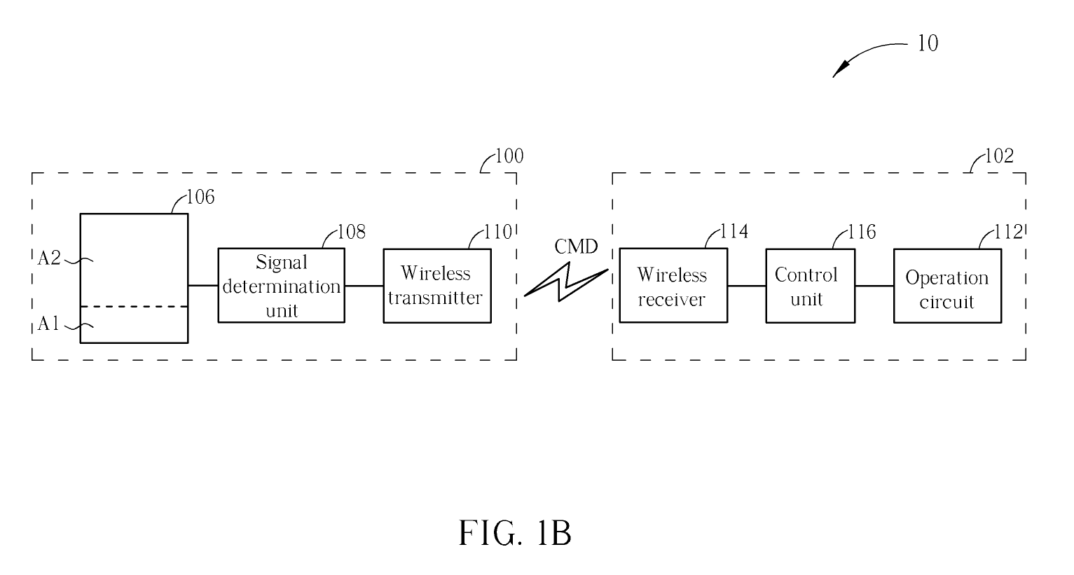

Please refer to FIGS. 1A and 1B. FIG. 1A is a schematic diagram of a multimedia system 10 according to an embodiment of the present invention. FIG. 1B is a functional block diagram of the multimedia system 10. The multimedia system 10 can enhance convenience, to avoid difficult operations due to small buttons, and comprises a remote control device 100 and a multimedia device 102. The remote control device 100 can control the multimedia device 102 via a wireless communication method, such as infrared, radio frequency, wireless networking, etc., and comprises a touch pad 106, a signal determination unit 108 and a wireless transmitter 110. The touch pad 106 is placed on a plane of a housing 104, and utilized for detecting a touch signal created by a user. The touch pad 106 is divided into areas A1 and A2. The area A1 is dedicated to detect a touch signal corresponding to an output effect of the multimedia device 102. When the area A1 receives the touch signal, a signal determination unit 108 inside the housing 104 generates a corresponding indication signal CMD and transmits the indication signal CMD to the multimedia device 102 via a wireless transmitter 110 set inside the housing 104. The multimedia device 102 is preferably a TV set, but not limited herein. The multimedia device 102 comprises an operation circuit 112, a wireless receiver 114 and a control unit 116. The wireless receiver 114 receives the indication signal CMD transmitted from the wireless transmitter 110 and conveys the indication signal CMD to the control unit 116. The control unit 116 controls the operation circuit 112 to perform the output effect needed by the user according to the indication signal CMD received by the wireless receiver 114.

In simple words, in the remote control device 100, the area A1 of the touch pad 106 is a dedicated touch area and dedicated to control the output effect of the multimedia device 102, such as volume, channel numbers, brightness, contrast, color saturation display settings. In this situation, once the user touches the area A1, the user, especially having poor eyesight, can quickly control the needed output effect, so as to enhance convenience and improve the difficult operation condition caused by small buttons.

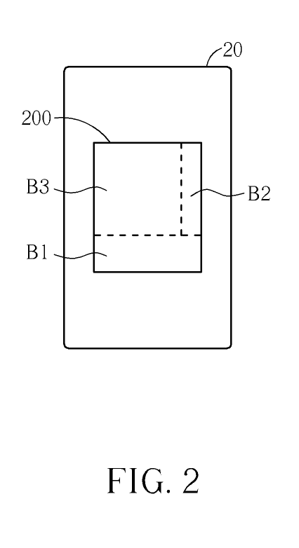

In FIGS. 1A and 1B, the area A1 is placed in the region below the touch pad 106. In fact, the position or quantity of the dedicated touch area is not limited to a specific rule. For example, FIG. 2 is a schematic diagram of a remote control device 20 according to an embodiment of the present invention. The structure and operation of the remote control device 20 are similar to those of the remote control device 100 shown in FIGS. 1A and 1B, and can replace the remote control device 100 for being applied in the multimedia system 10. The difference between the remote control device 20 and the remote control device 100 is that a touch pad 200 of the remote control device 20 is divided into areas B1, B2 and B3, and the areas B1 and B2 are dedicated touch areas and dedicated to detect touch signals of two output effects. In addition, in the remote control devices 100 and 20, operations of areas A2 and B3 are not limited to any specific rule, and for example, can utilize a technology disclosed in U.S. application Ser. No. 12/501,480 of the same applicant, to control other functions via the areas A2 and B3.

On the other hand, in the touch pad 106, the area A1 is utilized to detect the touch signal of a specific output effect, and the relationship between the output effect and the touch signal can be stored in a storage unit coupled to the signal determination unit 108. As a result, when the area A1 detects the touch signal, the signal determination unit 108 can determine the corresponding output effect and degree according to the information stored in storage unit. For example, if the area A1 is used to control the volume of the multimedia device 102 and the output volume range of the multimedia device 102 is between 0 and 50 decibels, then the area A1 can be divided into 50 grids from left to right and each grid in sequence corresponds to an output decibel. Thus, the user can click the area A1 to control the volume of the multimedia device 102. In order to prevent extreme high or low volume caused by inadvertent clicks in the above-mentioned procedure, relative pressing motions on the area A1 can be used to judge the corresponding output effect. For example, when the user quickly clicks the area A1, the signal determination unit 108 does not generate any indication signal, and when the user presses and slides toward left or right on the area A1, the signal determination unit 108 determines that the user wants to reduce (or increase) the volume.

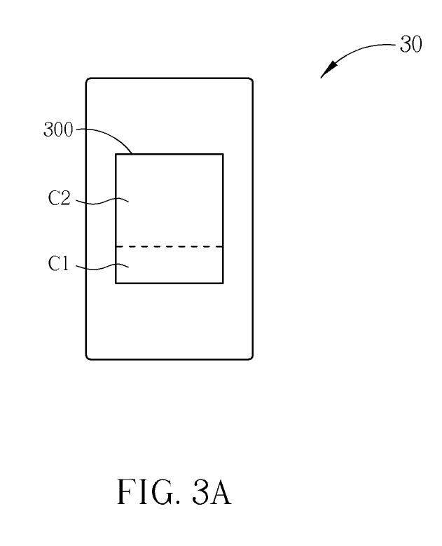

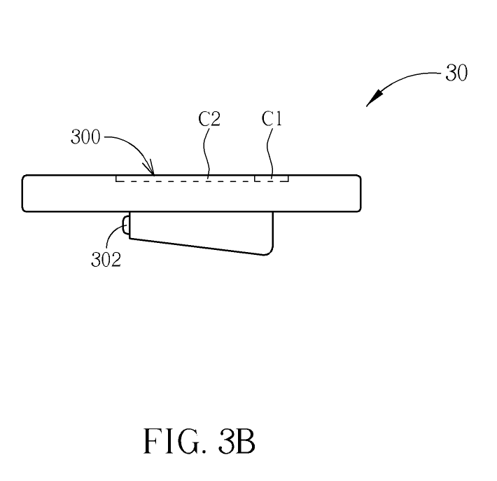

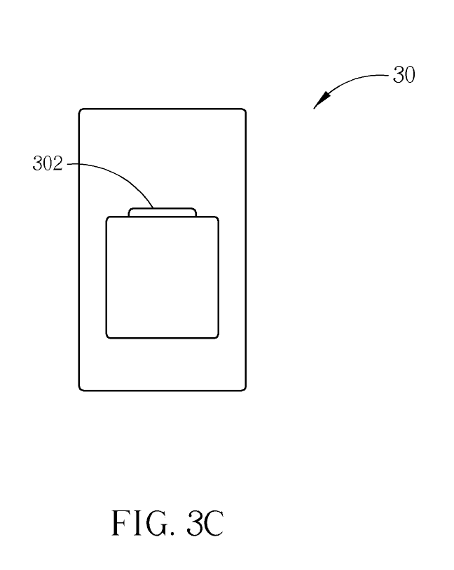

In addition, to broaden the application range of the remote control device 100 can add a setting mechanism for setting the output effect corresponding to the area A1 by the user. For example, please refer to FIGS. 3A, 3B and 3C, which are schematic diagrams of front view, lateral view and back view of a remote control device 30. The structure and operation of the remote control device 30 are similar to those of the remote control device 100 shown in FIGS. 1A and 1B, and can replace the remote control device 100 for being applied in the multimedia system 10. As can be seen from FIG. 3A, a front side of the remote control device 30 also comprises a touch pad 300, and the touch pad 300 is divided into areas C1 and C2. The difference between the remote control device 30 and the remote control device 100 is that the remote control device 30 adds a button 302 for setting the output effect corresponding to the area C1. Working with the button 302, the remote control device 30 needs to comprise a setting unit coupled to the corresponding signal determination unit for setting the output effect corresponding to the area C1 according to a setting signal generated when the button 302 is pressed. In other words, when the user presses the button 302, the user can switch the output effect controlled by the area C1. Note that, the button 302 is used to set the output effect controlled by the area C1, and can be realized by a touch pad or other devices. Furthermore, the button 302 for implementing the setting function can be realized by a plurality of buttons, and the related control method should be modified correspondingly. In other words, when there is only the button 302, if the user continuously clicks the button 302, then the remote control device 30 circularly switches the output effect controlled by the area C1, such as volume→channel number→volume→channel number and so on. If the remote control device 30 comprises a plurality of buttons, each button can be set to be used for triggering a specific setting result. For example, if the remote control device 30 comprises buttons X, Y and Z, then the buttons X, Y and Z can be set to switch the output effect controlled by the area C1 to volume, channel numbers and brightness respectively. Following this method, a designer can appropriately modify the remote control device of the present invention according to the system requirement.

Correspondingly, the multimedia device 102 can be appropriately changed or modified. For example, except for controlling the operation circuit 112 to perform the output effect, the control unit 116 can also control the operation circuit 112 to output a state signal corresponding to the output effect. For example, if the indication signal CMD is corresponding to control of increasing volume, then the control unit 116 can control the operation circuit 112 to display the changing status of volume as a reference for the user. Implementation of the operation circuit 112 for displaying the signal status is not limited to any specific rule, as long as the corresponding output effect can be correctly responded.

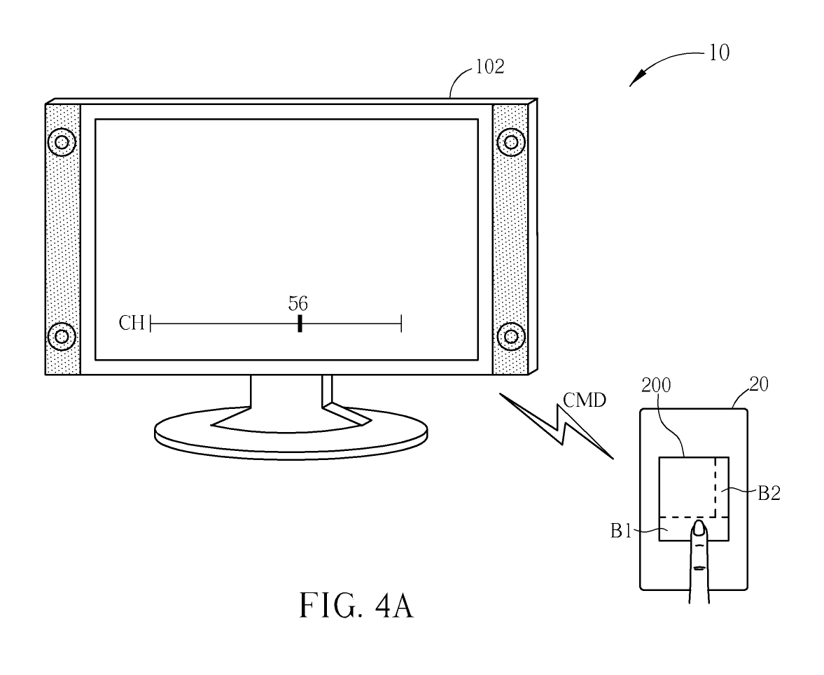

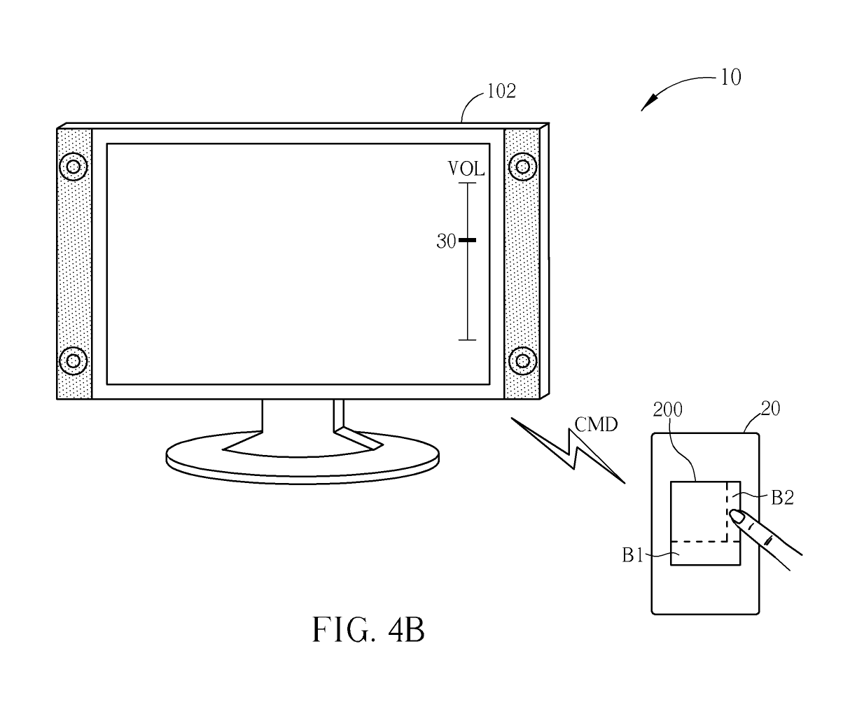

For example, suppose the remote control device 20 replaces the remote control device 100 for controlling the multimedia system 10, the area B1 is corresponding to the channel number control, and the area B2 is corresponding to the volume control. When the user touches and slides on the area B1, the multimedia device 102 shows a bar below, corresponding to the channel number, as shown in FIG. 4A. When the user touches and slides on the area B2, the multimedia device 102 shows a bar on the right side, corresponding to the volume, as shown in FIG. 4B.

As mention above, the present invention is to define a dedicated touch area in the touch pad of the remote control device, which is dedicatedly used for controlling a certain output effect of multimedia device. Outside the dedicated touch area, the rest areas of the touch pad can control functions of the multimedia device according to U.S. application Ser. No. 12/501,480. Taking the touch pad 106 as an example, the area A2 can be utilized to detect a sliding track of the user in order to generate a corresponding control signal. For example, “two fingers separate” indicates to turn on a TV set; “two finger close together” indicates to turn off the TV set; “one finger stands and another taps” represents to return to a previous channel; “one finger stands and another slides” indicates auto-scanning of channels and the auto-scanning is stopped after releasing the standing finger. Furthermore, acceleration of finger movement can be used to generate control signals, e.g. “twice fast sliding movements” indicates quick scan of channels. To avoid wrong touching, gestures can be added, e.g., after a gesture action, “L sliding track” indicates confirmation for enabling the gesture.

In the prior art, the font size of the traditional push-button remote control device is limited, causing utilization inconvenience, especially for users with poor eyesight, such that a presbyopic user has to take off glasses to operate the remote controller, then wear the glasses again, which does not meet the need of aging society. Meanwhile, the push-button remote controller is easily affected by dust, overuse, etc., leading to poor contact. In contrast, the present invention places the touch pad on the remote control device, replaces pressing actions by touching actions, and sets a dedicated touch area in the touch pad to control the specific output effect, such that the difficult operation due to small buttons can be avoided, as well as the poor contact issue.

To summarize, the present invention remotely controls the multimedia device through the touch pad and sets a dedicated touch area in the touch pad for controlling the specific output effect of the multimedia device. Therefore, the user can utilize fingers or touch pen to click or slide on the dedicated touch area, to perform desired output effects. In this way, the user keeps focus on the multimedia device, to reach the purpose of convenient operations.

Those skilled in the art will readily observe that numerous modifications and alterations of the device and method may be made while retaining the teachings of the invention.

What is claimed is:

1. A remote control device for a multimedia device comprising:
a housing;
a touch pad, placed on a plane of the housing and comprising a dedicated touch area;
a signal determination unit, placed inside the housing and coupled to the touch pad, for generating an indication signal corresponding to an output effect when the dedicated touch area receives a touch signal; and
a wireless transmitter, placed inside the housing and coupled to the signal determination unit, for wirelessly transmitting the indication signal to the multimedia device to control the multimedia device to perform the output effect.

2. The remote control device of claim 1, wherein the dedicated touch area is located on one side of the touch pad.

3. The remote control device of claim 1, further comprising a storage unit, coupled to the signal determination unit, for storing an associating information of the touch signal and the output effect.

4. The remote control device of claim 1, further comprising a setting unit, coupled to the signal determination unit, for setting the output effect according to a setting signal.

5. The remote control device of claim 4, further comprising a push button, for generating the setting signal.

6. The remote control device of claim 5, wherein the push button is placed on a plane of the housing, other than the plane of the touch pad.

7. The remote control device of claim 5, wherein the push button is a touch pad, for detecting a touch signal, to generate the setting signal.

8. The remote control device of claim 1, wherein the multimedia device is a television (TV) set.

9. The remote control device of claim 8, wherein the output effect is selected from a parameter group consisting of volume, channel numbers, display setting values, and combinations thereof.

10. A multimedia system comprising:
a remote control device comprising:
a housing;
a touch pad, placed on a plane of the housing and comprising a dedicated touch area;
a signal determination unit, placed inside the housing and coupled to the touch pad, for generating an indication signal corresponding to an output effect when the dedicated touch area receives a touch signal; and
a wireless transmitter, placed inside the housing and coupled to the signal determination unit, for wirelessly transmitting the indication signal to the multimedia device; and
a multimedia device comprising:
an operation circuit;
a wireless receiver, for wirelessly receiving the indication signal; and
a control unit, coupled to the operation circuit and the wireless receiver, for controlling the operation circuit to perform the output effect according to the indication signal.

11. The multimedia system of claim 10, wherein the dedicated touch area is located on one side of the touch pad.

12. The multimedia system of claim 10, further comprising a storage unit, coupled to the signal determination unit, for storing an associating information of the touch signal and the output effect.

13. The multimedia system of claim 10, further comprising a setting unit, coupled to the signal determination unit, for setting the output effect according to a setting signal.

14. The multimedia system of claim 13, further comprising a push button, for generating the setting signal.

15. The multimedia system of claim 14, wherein the push button is placed on a plane of the housing, other than the plane of the touch pad.

16. The multimedia system of claim 14, wherein the push button is a touch pad, for detecting a touch signal, to generate the setting signal.

17. The multimedia system of claim 10, wherein the multimedia device is a television (TV) set.

18. The multimedia system of claim 17, wherein the output effect is selected from a parameter group consisting of volume, channel numbers, display setting values, and combinations thereof.

19. The multimedia system of claim 10, wherein the control unit is further utilized for controlling the operation circuit to output a status signal corresponding to the output effect according to the indication signal.
